(19) United States
(12) Patent Application Publication
(10) Pub. No.: US 2013/0206163 A1
(43) Pub. Date: Aug. 15, 2013

(54) Methods and Systems For Removing Contaminants From A Wire Of A Saw

(71) Applicants: Carlo Zavattari, Varallo (IT); Ferdinando Severico, Cavaglietto (IT); Roland R. Vandamme, Wentzville, MO (US); Fabrizio Bonda, Villarboit (IT)

(72) Inventors: Carlo Zavattari, Varallo (IT); Ferdinando Severico, Cavaglietto (IT); Roland R. Vandamme, Wentzville, MO (US); Fabrizio Bonda, Villarboit (IT)

(73) Assignee: MEMC Electronic Materials, SPA, Novara (IT)

(21) Appl. No.: 13/585,547

(22) Filed: Aug. 14, 2012

Related U.S. Application Data
(60) Provisional application No. 61/524,981, filed on Aug. 18, 2011.

(51) Int. Cl. B08B 3/12

(52) U.S. Cl. CPC B08B 3/12
USPC 134/1; 134/184

(57) ABSTRACT

A system for ultrasonically cleaning one or more wires of a wire saw for slicing semiconductor or solar material into wafers. The system includes an ultrasonic transducer connected to a sonotrode. The system also includes a sonotrode plate adjacent to one or more of the wires. The sonotrode plate has an opening that exposes the sonotrode to one or more of the wires. The system further includes a tank for delivering a flow of liquid to contact the sonotrode and one or more of the wires. The tank is positioned on the same side of the wires as the sonotrode plate. The ultrasonic transducer is configured to vibrate and form cavitations in the liquid for the removal of contaminants from a surface of one or more of the wires.

### CROSS REFERENCE

This application claims priority to U.S. Provisional Application No. 61/524,981 filed on Aug. 18, 2011, the entire disclosure of which is hereby incorporated by reference in its entirety.

### FIELD

The field relates generally to the removal of contaminants from a wire of a saw for slicing semiconductor or solar material into wafers, and more specifically to using ultrasonic agitation to remove contaminants from the wire.

### BACKGROUND

Wafers used for semiconductors and solar cells are typically cut with a wire saw from an ingot made of silicon, sapphire, germanium or the like. The wire saw cuts the ingot by contacting the ingot with a wire covered in abrasive slurry. The abrasive slurry is typically comprised of a fine abrasive, such as silicon carbide (SiC) or an industrial diamond suspended in a liquid suspension medium.

In operation, the ingot is cut by applying force to the wire to press the wire against the ingot. The abrasive slurry is drawn in between the wire and the ingot and thereby abrades the ingot and removes fine particles, chips, or shavings (collectively referred to as “swarf”) from the ingot. The fine particles are carried away from the interface of the wire and the ingot by the abrasive slurry. The particles are thereby mixed with the slurry. Eventually, the concentration of swarf in the slurry increases to a point where the slurry is no longer effective. The slurry is either processed to remove the swarf or disposed.

Some wire saws use a wire coated with industrial diamonds to cut the ingot into wafers. These saws do not require the use of abrasive slurry. A liquid is used to cool the wire during operation of the saw. The diamond-coated wire used in these systems is many times more expensive than the wire used in other previous systems. During use, the wire becomes coated with swarf and/or other contaminants. This coating reduces the efficacy of the wire and thus increases the amount of time required to cut the ingot into wafers and the amount of wire used to cut the ingot. Accordingly, a satisfactory method and/or system of reducing the accumulation of swarf on a diamond-coated wire is needed.

This Background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF SUMMARY

A first aspect is a system for ultrasonically cleaning one or more wires of a wire saw for slicing semiconductor or solar material into wafers. The system includes an ultrasonic transducer connected to a sonotrode. The sonotrode is positioned adjacent to one or more of the wires. The system also includes a tank for delivering a flow of liquid to contact the sonotrode and one or more of the wires. The tank is positioned on the opposite side of the wires from the sonotrode. The ultrasonic transducer is configured to vibrate the sonotrode and form cavitations in the liquid for removal of contaminants from a surface of one or more of the wires.

A second aspect is another system for ultrasonically cleaning one or more wires of a wire saw for slicing semiconductor or solar material into wafers. The system includes an ultrasonic transducer connected to a sonotrode. The system also includes a sonotrode plate adjacent to one or more of the wires. The sonotrode plate has an opening that exposes the sonotrode to one or more of the wires. The system further includes a tank for delivering a flow of liquid to contact the sonotrode and one or more of the wires. The tank is positioned on the same side of the wires as the sonotrode plate. The ultrasonic transducer is configured to vibrate and form cavitations in the liquid for the removal of contaminants from a surface of one or more of the wires.

Another aspect is a method for ultrasonically cleaning one or more wires of a wire saw for slicing semiconductor or solar material into wafers. The method includes ultrasonically agitating a liquid in contact with one or more of the wires to cause cavitation in the liquid. The method also includes cleaning one or more of the wires by removal of contaminants deposited on one or more of the wires using the cavitations in the liquid.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 is a perspective view of a wire saw and a system for cleaning wires used in the saw.

FIG. 2 is a side view of the wire saw and system of FIG. 1.

FIG. 3 is a perspective view of an inner assembly of the system for cleaning wires of FIG. 1.

FIG. 4 is a perspective view of an outer assembly of the system for cleaning wires of FIG. 1.

FIG. 5 is an enlarged, exploded perspective view of the inner assembly of FIG. 3.

FIG. 6 is an enlarged perspective of the inner assembly of FIG. 3.

FIG. 7 is an exploded, enlarged perspective view of the outer assembly of FIG. 4.

FIG. 8 is an enlarged perspective view of the outer assembly of FIG. 4.

FIG. 9 is a perspective view of another embodiment of a wire saw and a system for cleaning wires used in the saw.

FIG. 10 is a side view of the system of FIG. 9.

FIG. 11 is an end view of the system of FIG. 9.

FIG. 12 is a partially schematic view of yet another embodiment of a system for cleaning wires used in a wire saw.

FIG. 13 is a perspective view of another embodiment of a system for cleaning wires used in a wire saw.

FIG. 14 is an enlarged view of a portion of a diamond-coated with contaminants deposited on its surface.

FIG. 15 is an enlarged view of a portion of the wire of FIG. 14.

FIG. 16 is an enlarged view of the portion of the wire of FIGS. 14 and 15 after the wire has been cleaned by one of the systems of FIGS. 1-13.

FIG. 17 is a graph showing the total thickness variation for the surfaces of wafers cut using the prior system and wafers cut using the systems of FIGS. 1-13.

FIG. 18 is a perspective view of another embodiment of a system for cleaning wires used in a wire saw.

FIG. 19 is an enlarged view of the outer assembly of FIG. 18.

Like reference symbols in the various figures indicate like elements.

### DETAILED DESCRIPTION

The embodiments described herein are generally directed to systems and methods of using ultrasonic energy to clean cutting wires. For example, the embodiments described herein may be used to clean wires used in semiconductor or solar (e.g., silicon, silicon-germanium, germanium, sapphire, etc.) wafer slicing (i.e., cutting) processes. According to the example embodiment, these wires are coated with industrial diamonds. Other embodiments, while not explicitly described herein, may clean different types of wires or wires used in different cutting processes.

The embodiments described herein relate to the cleaning of wires used in wire saws. These wire saws are used to slice larger pieces of semiconductor or solar material (e.g., semiconductor or solar material ingots) into smaller pieces of material (e.g., wafers). Prior to initiation of the wire slicing operation, the diamond-coated wires of the wire saw are substantially free from contamination. In prior systems, these wires become coated with swarf or other contaminants during cutting of the semiconductor or solar material. The terms “contaminants” and “swarf” are used interchangeably herein and the usage of one does not exclude the other.

The coating of swarf or other contaminants from the semiconductor or solar material and/or wires reduces the efficacy of the diamond-coated wires in at least two ways. First, the coating increases the coefficient of friction of the wire, thus increasing the amount of force required to pull the wires through the ingot. Second, the coating also smoothes the previously rough, abrasive surface of the diamond-coated wires such that their ability to cut the semiconductor is significantly reduced. Prior systems attempted to combat the buildup of swarf on the wires by adding a surfactant to a liquid used to cool the wires and the semiconductor. The use of this surfactant, however, has failed to reduce the concentration of swarf coating to an acceptable level.

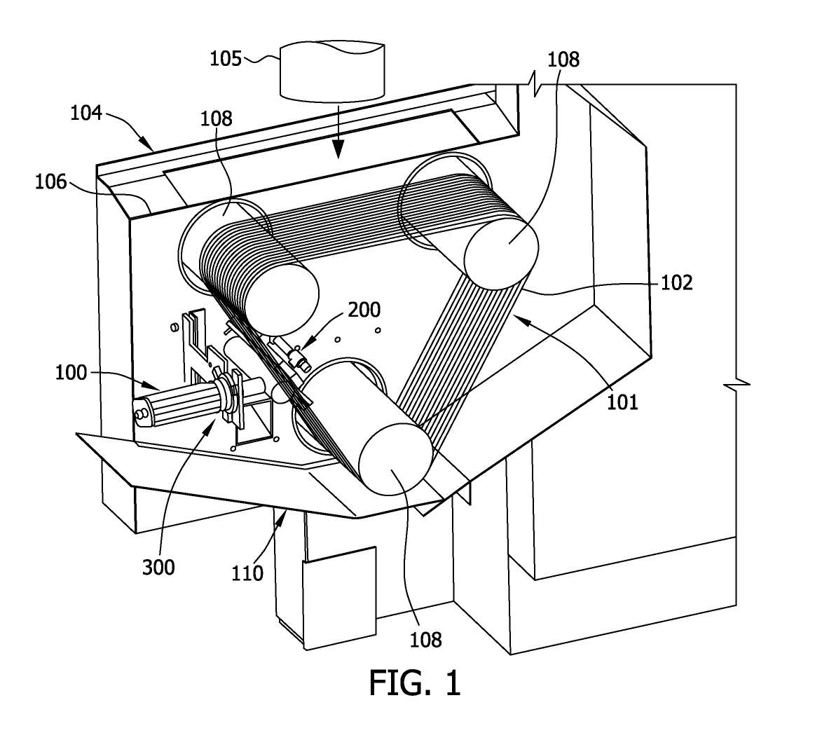

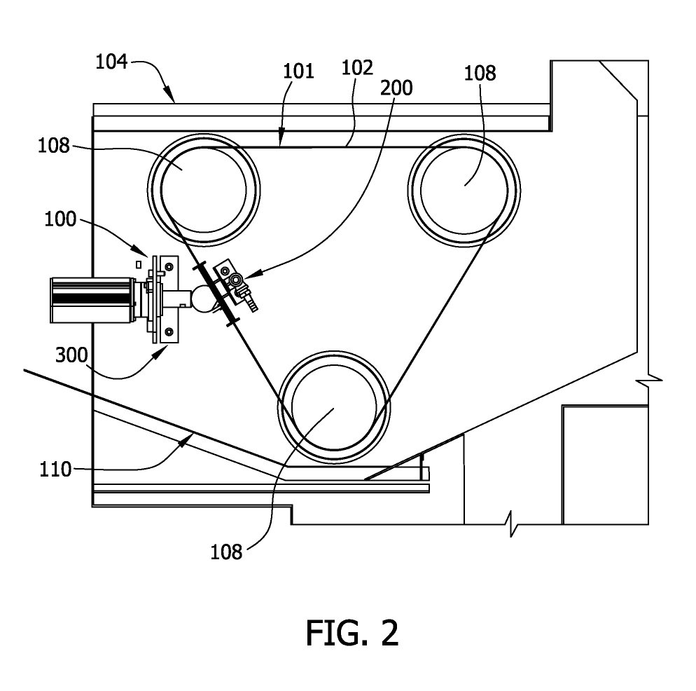

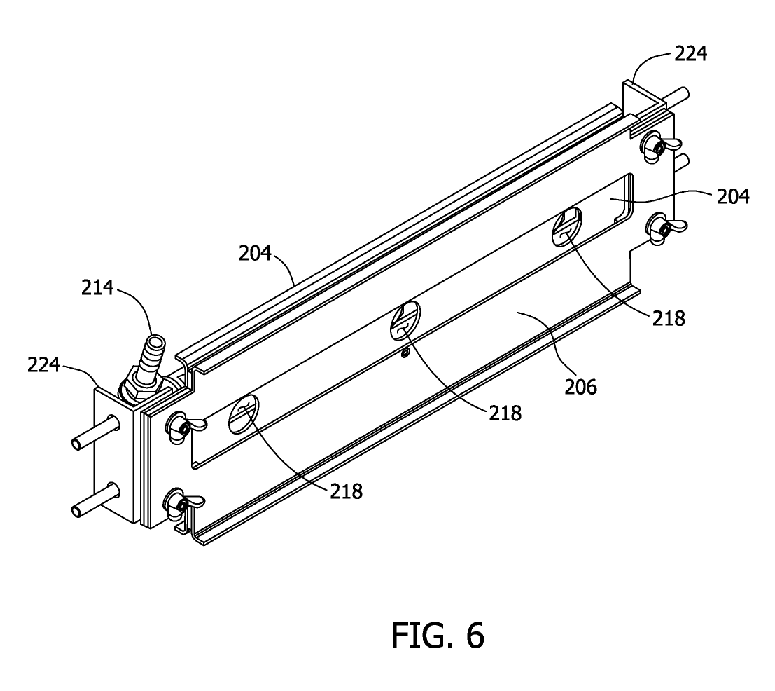

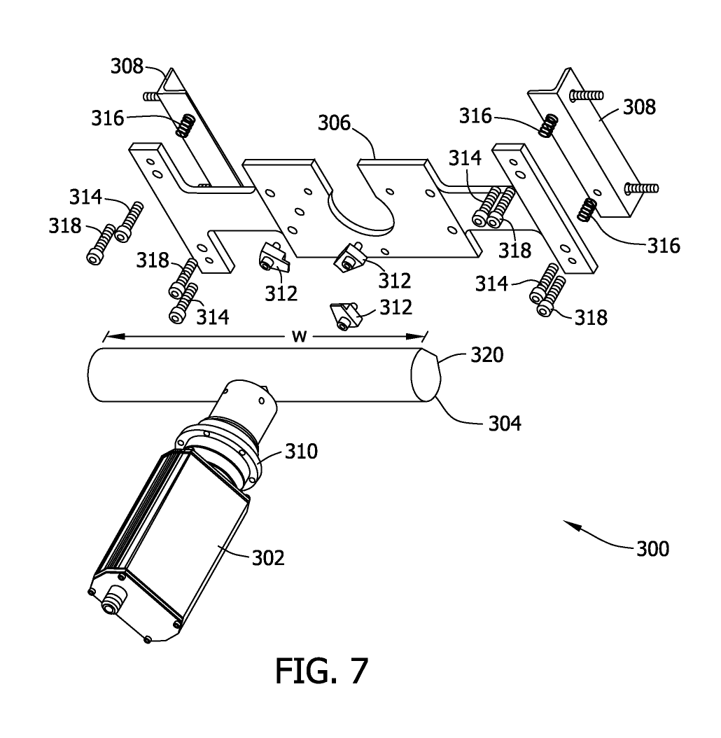

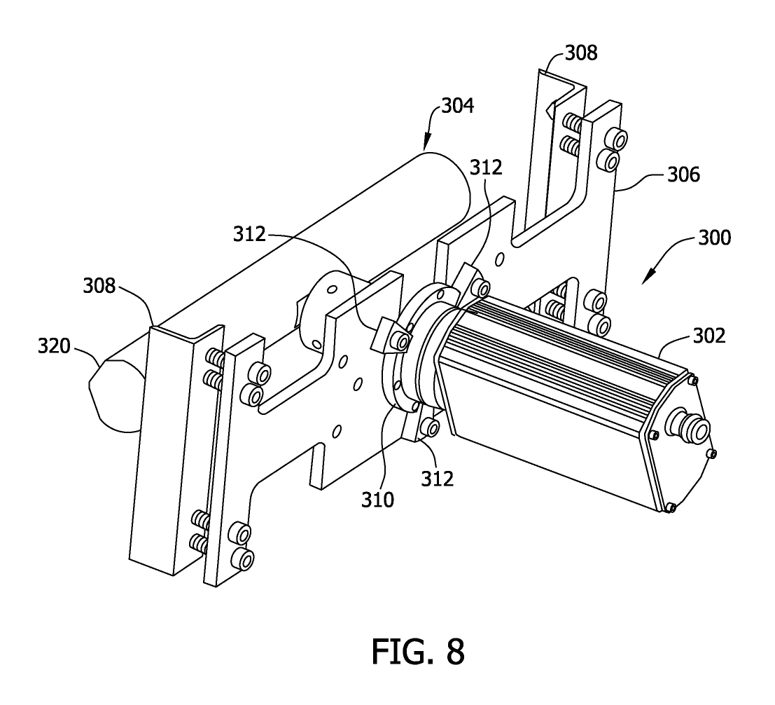

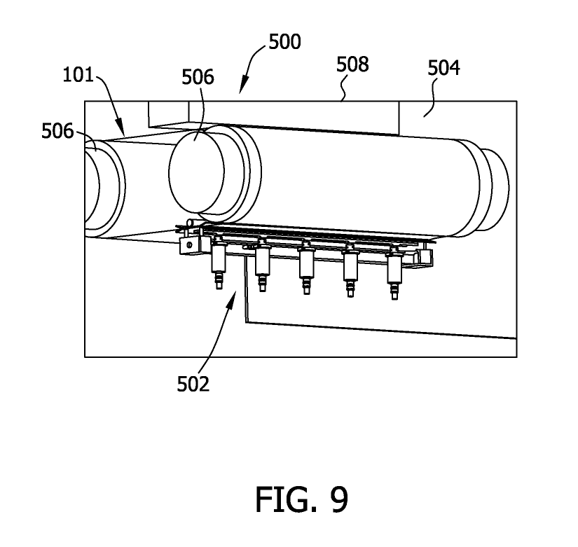

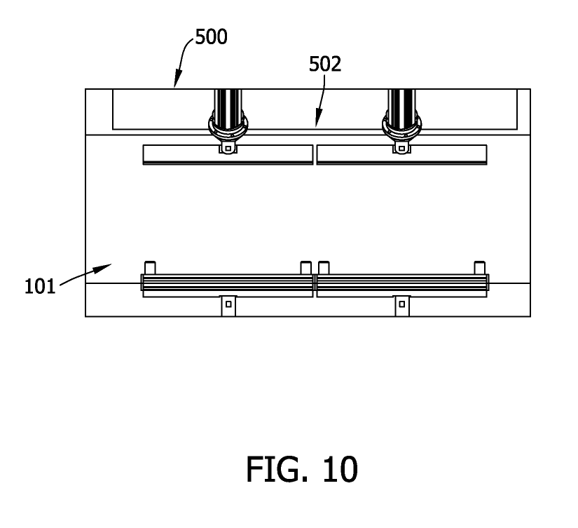

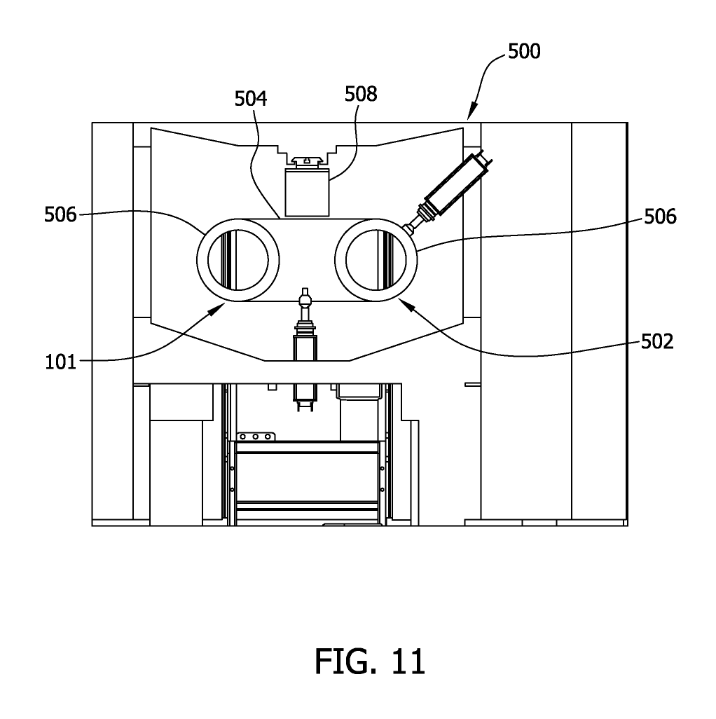

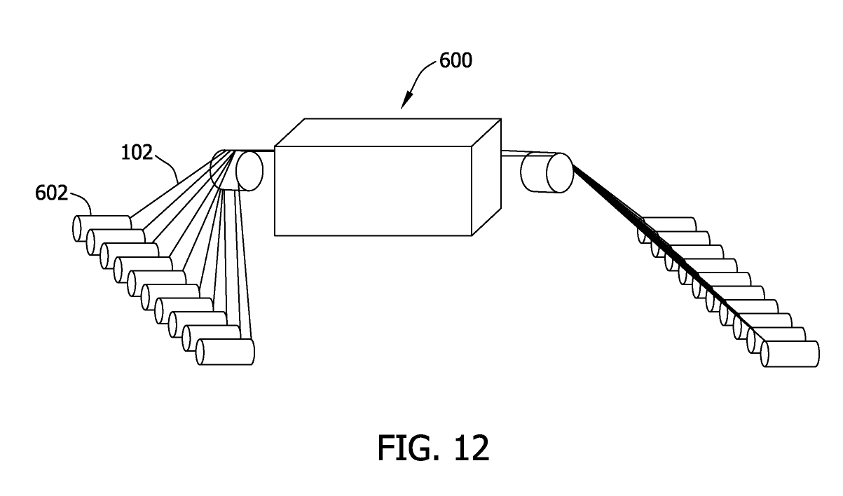

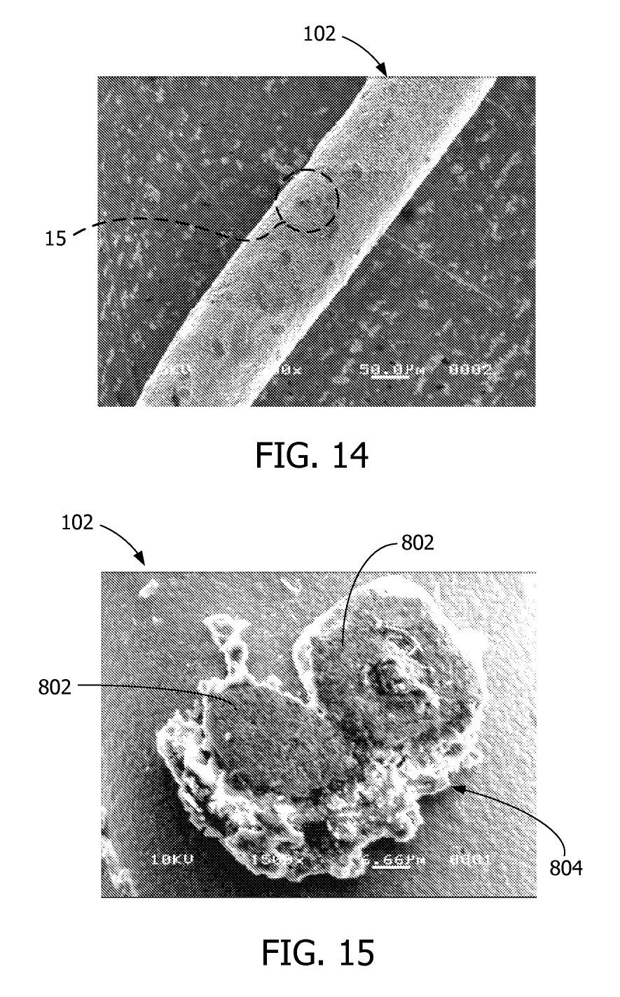

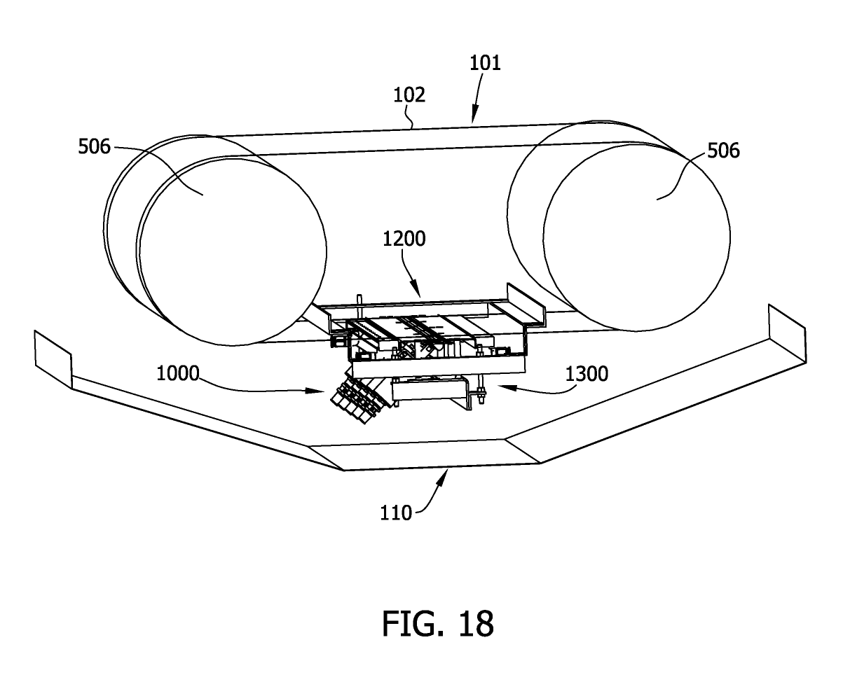

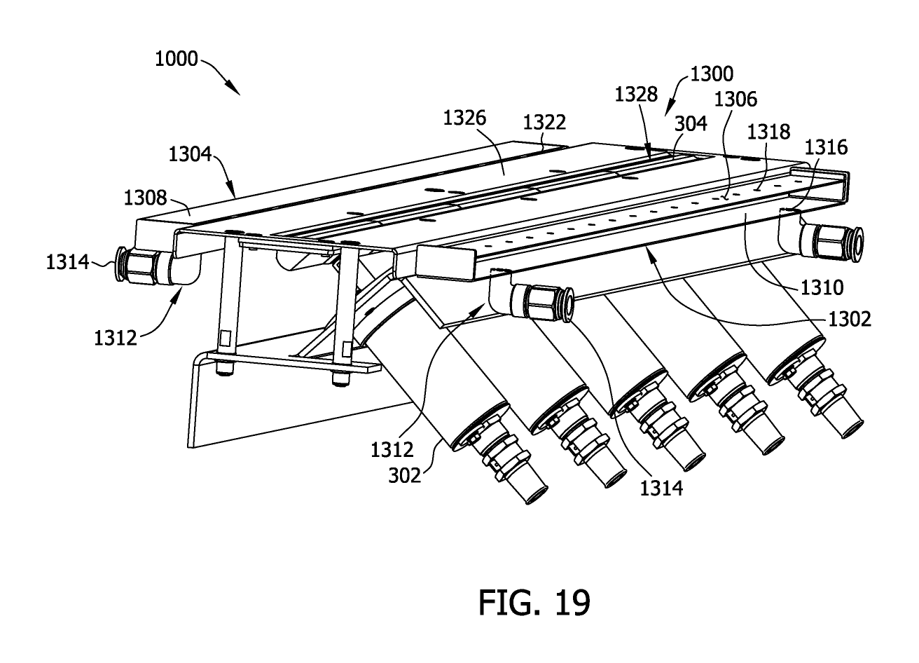

The systems described herein use an ultrasonic cleaning system to remove swarf from the diamond-coated wires. In these embodiments, the diamonds are adhered to the wires according to any suitable method. In a first example embodiment, an ultrasonic cleaning system shown in FIGS. 1-8 and designated generally at 100 is disclosed, which is operable to clean the wires 102 of a wire saw 104 while the wires are disposed in the saw. In a second embodiment shown in FIGS. 9-11 and designated generally at 500, multiple ultrasonic cleaning systems 502 are used to clean the wires 102 of another type of wire saw 504. In this embodiment, the system 500 is operable to clean the wires 102 while the wires are disposed in the saw 504. In a third example embodiment shown in FIG. 12 and indicated generally at 600 an ultrasonic cleaning system is disclosed which is operable to clean wires 102 while they are not disposed in a saw. In a fourth embodiment shown in FIG. 14 and indicated generally at 700, an ultrasonic system 700 similar to that of the system 600 is used to clean the wires 102 prior to and/or after the wires are wound and/or unwound from a spool. In a fifth embodiment shown in FIGS. 18 and 19 and designated generally at 1000, at least one ultrasonic cleaning system is used to clean the wires 102 of a wire saw 104 while the wires are disposed in the saw.

With reference now to the first embodiment shown in FIGS. 1-8, a system 100 for cleaning a web 101 of wires 102 used in a wire saw 104 is disclosed. In this embodiment, the wire saw is used to slice an semiconductor or solar material ingot 105 that is brought into contact with the wires 102, for example in the direction of the arrow shown in FIG. 1. Only one wire 102 of the web 101 is numbered for brevity, however the web may include a plurality of wires 102 that extend substantially parallel to one another (FIG. 1). The saw 104 has a frame 106 with three wire guides 108 attached to the frame. In this embodiment, the wire 102 is continuous and has a first end attached to a first spool and a second end attached to a second spool, both of which are not shown. Wire 102 may be wrapped one or more times around wire guides 108 creating a series of parallel cutting surfaces of the wire. The first and second spools are connected to suitable drive sources that are operable to rotate the first and second spools to pull the wire 102 along the wire guides 108. In some embodiments, a plurality of discrete wires are positioned around the wires guides 108.

The wire guides 108 are configured to maintain a set spacing between the wires 102 of the web 101. This spacing corresponds to a desired thickness of wafers sliced from the semiconductor or solar material. The wire guides 108 may have grooves (not shown) or other similar features formed on their outer surfaces to maintain this spacing between the wires 102 of the web 101. The wire guides 108 may also be movable to adjust the spacing between each wire guide to adjust the tension on the wires 102 of the web 101.

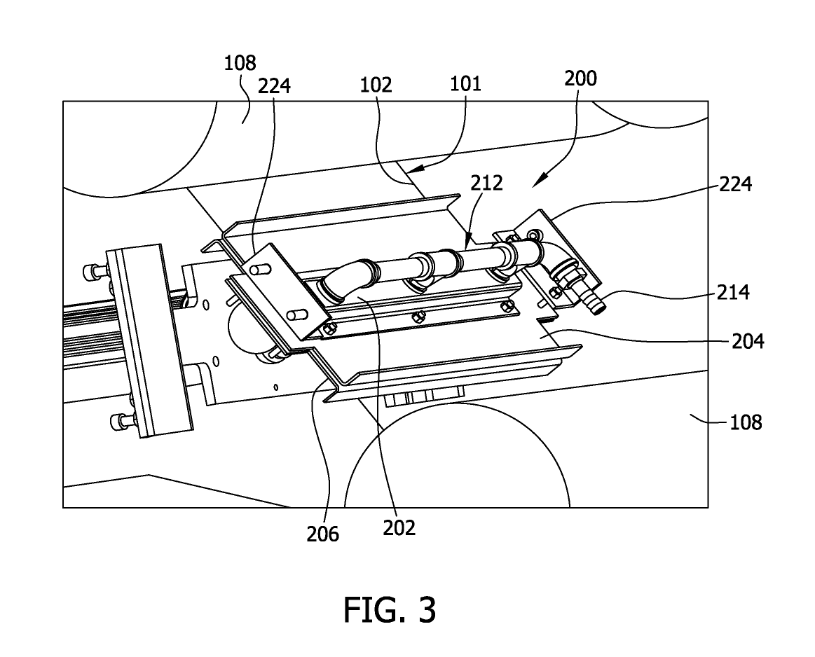

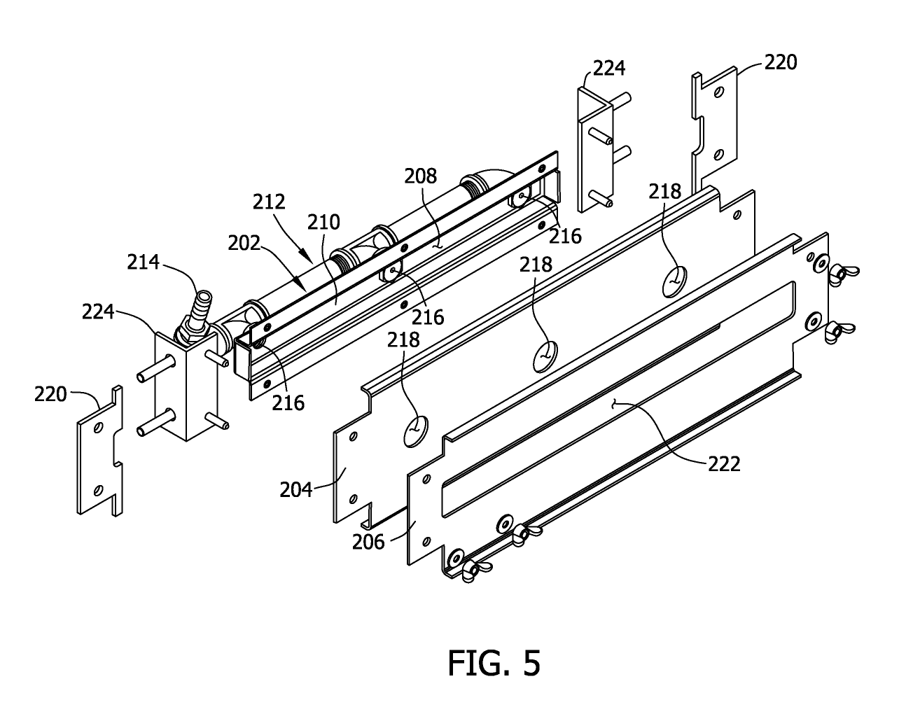

In this embodiment, the system 100 includes an inner portion 200 and an outer portion 300 connected together by any suitable fastening system. As best seen in FIGS. 3, 5, and 6, the inner portion 200 contains a tank 202 for holding liquid (e.g., coolant), a back plate 204, and a front plate 206. In the exemplary embodiment, the tank 202 is a five-sided structure and has an open front portion 208 opposite a closed back portion 210. The tank 202 is supplied with liquid by a manifold 212 (FIGS. 3 and 5) that has an inlet 214 connected to a source of liquid (not shown). The manifold 212 has a plurality of openings 216 that are in fluid communication with corresponding openings formed in the back portion 210 of the tank 202. In the example embodiment, the manifold 212 has three openings 216 and the back portion 210 of the tank 202 has three corresponding openings, although other embodiments may use different numbers of openings and/or orifices. Moreover, some embodiments may not use a manifold to supply the tank 202 with liquid and instead may connect the openings in the tank 202 directly to the source of fluid with suitable tubes or pipes.

The back plate 204 and the front plate 206 are spaced apart to permit the web 101 of wires 102 to pass between the back and front plates without contacting either of the plates. In the example embodiment, two spacers 220 are positioned between the front plate 206 and the back plate 204 generally adjacent their opposing edges to ensure that the plates remain spaced apart during use. In other embodiments, different numbers or configurations of spacers may be used to maintain the spacing between the front plate 206 and the back plate 204. The back plate 204 and the front plate 206 are connected together by suitable fasteners. While the front plate 206 is connected to the inner portion 200, it is located opposite the web of wires 102 in the outer portion 300.

In the exemplary embodiment, back plate 204 has three openings 218 formed therein that are generally in alignment with the openings 216 formed in the manifold 212 and the openings in the tank 202. These openings 218 permit liquid to flow from the tank 202 through the back plate 204 and into contact with the web 101 of wires 102. The front plate 206 has an elongated opening 222 formed therein, the purpose of which is described below. A pair of brackets 224 are disposed on opposing edges of the inner portion 200 and are used to secure the inner portion to the frame 106 of the saw 104 or another intermediate structure (not shown).

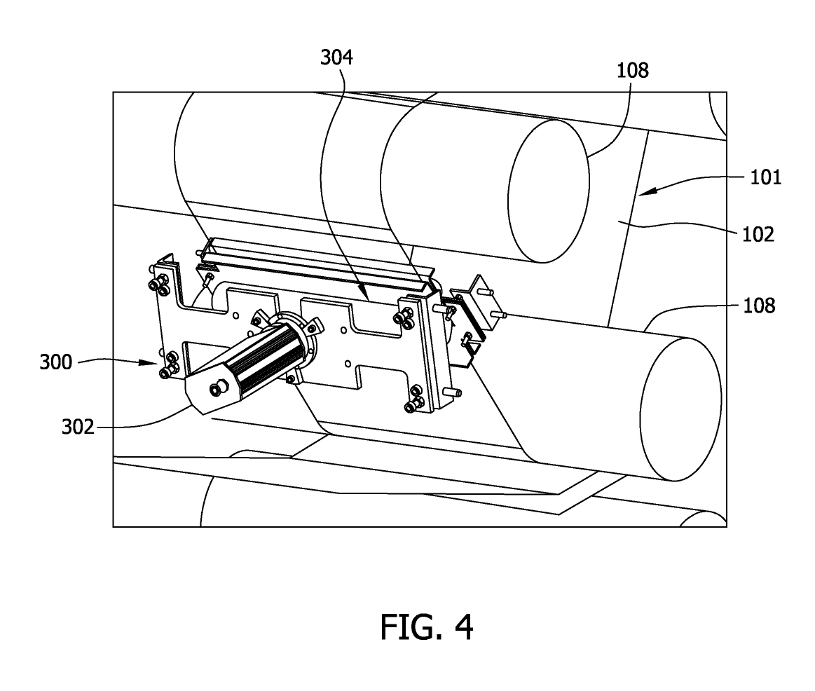

With reference now to FIGS. 4, 7, and 8, the outer portion 300 includes an ultrasonic transducer 302 and a sonotrode 304 connected to the transducer. The transducer 302 and the sonotrode 304 are connected to the frame 106 of the wire saw 104 by a frame 306 and a pair of brackets 308 connected to the frame. The transducer 302 has a collar 310 connected to the frame 306 by a plurality of fasteners 312. The frame 306 is connected to the brackets 308 by a plurality of fasteners 314. Springs 316 are positioned between the frame 306 and the brackets 308 in the example embodiment to substantially prevent loosening of the fasteners. A plurality of adjustment screws 318 are provided to permit adjustment of the relative position of the frame 306 to the brackets 308.

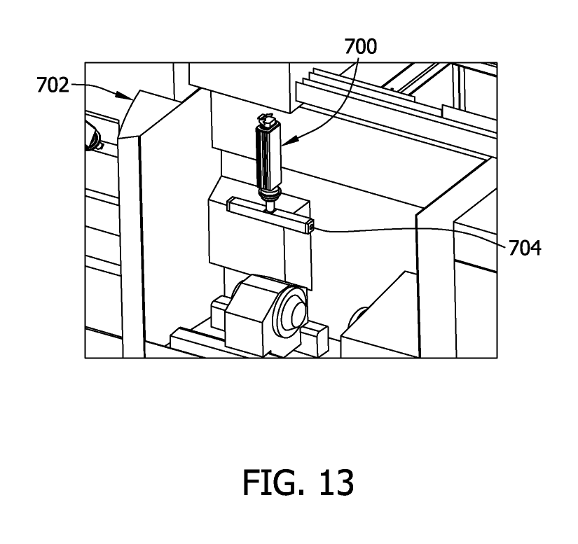

The transducer 302 and the sonotrode 304 are connected by any suitable fastening system in the example embodiment (e.g., mechanical fasteners). The sonotrode 304 has a width W that is substantially the same as the width of the web 101 of wires 102, although the width W may be greater or less than the width of the web of wires in other embodiments. The sonotrode 304 is generally cylindrical in the example embodiment and has a flattened face 320 that is positioned nearest the web 101 of wires 102 when in use. In other embodiments the sonotrode 304 may be shaped differently without departing from the scope of this disclosure. For example, the sonotrode 304 may have a square or rectangular shape in some embodiments (e.g., FIG. 13).

In this embodiment, the ultrasonic transducer 302 has a power rating of between about 50 W/m² and 200 W/m². The ultrasonic transducer 302 is connected to a suitable control system (not shown). This control system is operable to control the amount of power output by the transducer 302, and hence the magnitude of ultrasonic vibrations generated by the sonotrode 304. Moreover, the control system is also operable in the example embodiment to vary the frequency of the power output by the transducer 302, and thus the frequency of ultrasonic vibrations generated by the sonotrode 304. In the example embodiment, the ultrasonic vibrations generated by the sonotrode 304 may be between about 10 kHz and 30 kHz.

The second example embodiment, shown in FIGS. 9-11, differs from the first embodiment in the number of ultrasonic cleaning systems 502 used to clean the web 101 of wires 102. The system of FIGS. 9-11 has multiple systems 502, compared to the single system 100 of the embodiments of FIGS. 1-8. Moreover, in this embodiment, the saw 504 includes two wire guides 506. In this embodiment, the wire saw 504 is used to cut a multi-crystalline ingot 508 into wafers used in the production of photovoltaic devices. However, the saw 504 may be used to cut any other suitable semiconductor or solar material. Each of the ultrasonic cleaning systems 502 shown in FIGS. 9-11 are the same as, or substantially similar to, those described above in reference to FIGS. 1-8.

The third example embodiment shown in FIG. 12 discloses an ultrasonic cleaning system 600 for use in cleaning one or more wires 102 while the wires are not disposed in a wire saw. In this embodiment, the ultrasonic cleaning system 600 is shown schematically. This system 600 is operable to clean the wires 102 off-line while the wires are not being used in a slicing operation by the saw. In operation, after one or more of the diamond-coated wires 102 is used to cut the semiconductor or solar material into wafers, it is wound on a spool 602. The wire 102 is then unwound off of this spool 602 and fed through the cleaning system 600 to remove swarf from the surface of the diamond-coated wire 102. In this embodiment, the wire 102 is fed through the system 600 at a rate of about one to five m/s, which may allow the swarf to be removed from the surface of the wire in one pass through the system 600. In other embodiments, the feed rate of the wire 102 may be increased or decreased and/or the wire may be fed through the system multiple times.

The system 600 may contain components that are the same as or substantially similar to those described above in reference to FIGS. 1-9. However, because the system 600 is configured to clean one or more wires 102 in a single pass, the sonotrode 304 of the system 600 may have a width less than the sonotrodes used in either of the exemplary systems shown in FIGS. 1-9. The example embodiment of FIG. 12 is configured to clean 10 individual wires substantially simultaneously. Other embodiments are configured to clean more or less wires substantially simultaneously. Moreover, the transducer may have a lesser or greater power rating than those described above. Alternatively, the system of FIG. 12 may use the same or substantially similar sonotrodes and/or transducers as those described above, with reference to other embodiments.

In a fourth embodiment shown in FIG. 13, a cleaning system 700 similar to the system 600 of FIG. 12 is used to clean the wire 102 while it is being used in the saw 702. In this embodiment, the system 700 is disposed adjacent to a wire management system (not shown) used by the saw 702 operable to feed and pull wire 102 through the saw and around the wire guides and the wire 102 passes through an opening 704 in the sonotrode. This wire management system uses two spools (not shown). In operation, wire is dispensed off of a first spool and fed through the saw and is then wound around a second spool. After the wire has been unwound from the first spool and wound around the second spool, the direction of travel of the wire reverses and the wire is unwound from the second spool, fed through the saw, and wound around the first spool. This back-and-forth process continues until the ingot has been sliced into wafers. The system 700 is positioned such that it cleans the wire 102 before it is wound onto one of the spools and/or as the wire is unwound from one of the spools and fed back into the saw. Moreover, a second cleaning system similar to or the same as the system 700 may be positioned adjacent the other spool.

In a fifth exemplary embodiment, shown in FIGS. 18 and 19, multiple ultrasonic cleaning systems 1000 are used, although only one system or other numbers of systems may be used. In this embodiment, tank 1302 and/or tank 1304 are positioned on the outer portion 1300 of the system 1000. The inner portion 1200 and the outer portion 1300 are connected by any suitable fastening system. In this embodiment, the outer portion 1300 contains two tanks 1302, 1304 for holding liquid on either side of a sonotrode plate 1326. One or more of the tanks 1302, 1304 are supplied with liquid by manifolds 1312 that have an inlet 1314 connected to a source of the liquid (not shown). In the example embodiment, the tanks 1302, 1304 both have two manifolds 1312, although other embodiments may use a different number of manifolds. The tanks 1302, 1304 may have more than one inlet 1314 attached to each tank, for example to supply multiple different liquids. In other embodiments, one or more inlets 1314 may instead function as an outlet. Moreover, some embodiments may not use a manifold 1312 to supply the tanks 1302, 1304 with liquid and instead may connect the openings in the tank directly to the source of fluid with suitable tubes or pipes.

As shown in FIG. 19, a surface plate 1308 of tank 1302 is omitted to show the inside features of tank 1302. Between the back portion 1310 of the tank 1302 and the surface plate 1308 is an inner tank plate 1306 with a plurality of openings 1318. The inner tank plate 1306 may function as a manifold to distribute liquid. In this embodiment, the inner tank plate 1306 has seventeen openings 1318, although other embodiments may use different numbers of openings. In the example embodiment, the surface plate 1308 has nine elongated openings 1322, although other embodiments may use different numbers, shapes and sizes of openings. The elongated openings 1322 are located along the longitudinal edge of the surface plate 1308, adjacent to the sonotrode plate 1326. The inner tank plate 1306, the surface plate 1308, and the closed back portion of the tank 1310 are connected together by suitable fasteners and/or brackets.

In this embodiment, a sonotrode plate 1028 is disposed between the tanks 1302, 1304. The sonotrode plate 1326 has a sonotrode opening 1328 where one or more sonotrodes 304 are positioned. The sonotrode opening 1328 allows for the sonotrodes 304 to come in contact with the liquid exiting from one or more of the tanks 1302, 1304 out of the elongated openings 1322. The liquid flows from the tanks 1302, 1304 and into contact with the web 101 of wires 102 and the sonotrode 304 outside of the elongated openings 1322 to clean the wires.

The systems described above remove swarf and/or other contaminants deposited on the surface of the wire with ultrasonic vibration. These systems use one or more sonotrodes to ultrasonically vibrate a liquid surrounding the wires. This liquid is supplied by the manifold into the tank and flows from the tank to contact the web of wires and the sonotrode. This ultrasonic vibration of the liquid results in cavitation of the liquid, which in turn dislodges silicon swarf from the surface of the wires. As shown in FIGS. 1, 2, and 18, a collection channel 110 surrounds a portion of the systems for collecting liquid that falls from the ultrasonic cleaning device.

In the systems described in the first, second, and fifth example embodiments, the ultrasonic cleaning systems are operated to clean one or more wires while the saws are slicing the semiconductor or solar material into wafers. In the third embodiment, the system is operable to clean the one or more wires off-line, i.e., while it is not being used in the saw. In this embodiment, the wires may be removed from the saw after being coated with swarf, and then fed through the system by attaching one end of the wire to a spool or other structure and then feeding or pulling the wire through the system. The wire is thus subject to ultrasonic cleaning as it passes through the system. In fourth embodiment, multiple wires may be fed through this system at substantially the same time such that the multiple wires are cleaned in parallel.

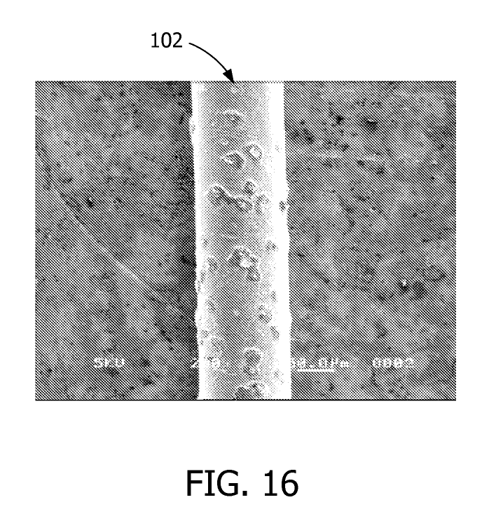

FIG. 14 shows an exemplary wire 102 after being coated with swarf and FIG. 15 shows an enlarged portion of the wire of FIG. 14. Swarf 804 surrounding the diamonds 802 disposed on the surface of the wire 102 is shown in FIG. 15. FIG. 16 depicts the wire 102 after it has been cleaned by an ultrasonic cleaning system of the present disclosure. As shown in FIG. 16, the ultrasonic cleaning system removes substantially all of the swarf 804 deposited on the surface of the wires 102. The systems described herein may result in the efficient removal of swarf from the surface of the diamond-coated wire.

As described above, one previous attempt to reduce the effects of swarf coating on the wires was to increase the length of the wires to reduce the concentration of the swarf coating. However, increasing the length of the diamond-coated wire increases the operational costs of the saw. Known systems typically required approximately 8 meters of wire per wafer sliced. The ultrasonic cleaning systems described herein allow lengths less than 8 meters of diamond-coated wire to be used in the wire saws. In some embodiments using the cleaning systems described herein, approximately 4 meters of wire or less per wafer sliced is used. Because the cost of the wire may form a significant portion of the operational costs of the saw (and hence the cost of the wafers), a reduction in the amount of wire needed to slice each wafer may reduce the costs to slice the semiconductor or solar material into wafers.

Moreover, the systems of the first, second, and fifth example embodiments are operable to clean the diamond-coated wire while the saw is slicing the semiconductor or solar material into wafers. Thus swarf deposited on the surface of the diamond-coated wire can be promptly removed by the cleaning system and substantially prevented from building up and reducing the efficacy of the saw. Accordingly, the amount of time required for the saw to cut the semiconductor or solar material into wafers is significantly reduced compared to known saws. For example, known saws may require approximately seven hours to slice a 200 mm ingot into wafers, while saws using the exemplary cleaning systems described herein may be capable of slicing a 200 mm ingot into wafers in approximately three hours. Furthermore, known saws may require approximately nine hours to saw a 156 mm×156 mm multi-crystalline ingot into wafers, while saws using the exemplary cleaning systems described herein may be operable to do so in approximately four and one-half hours. Similarly, known systems require approximately five days to slice 200 mm sapphire semiconductor material in a crystallographic plane into wafers, while saws using the exemplary cleaning systems described herein may be operable to do so in approximately 50 hours.

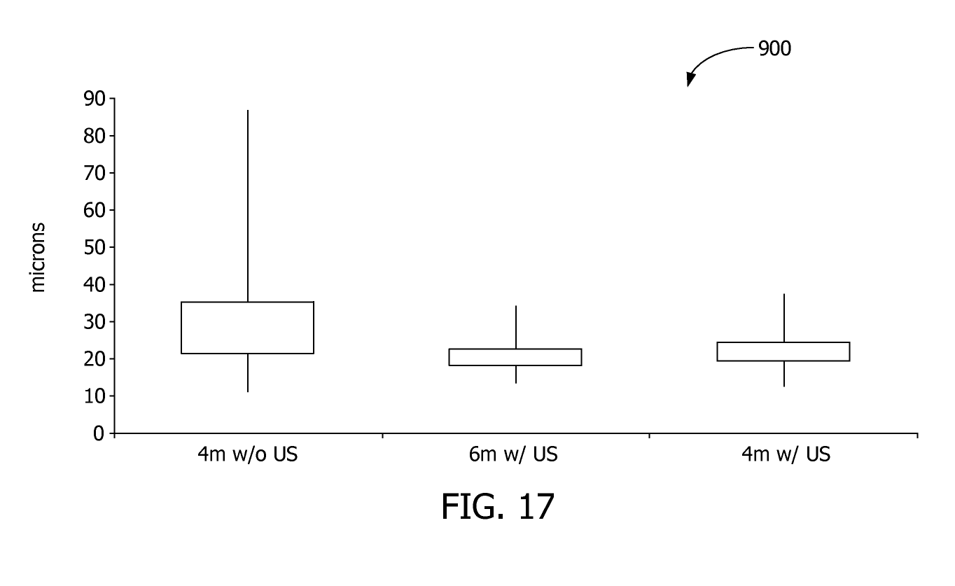

FIG. 17 depicts a graph 900 displaying measurements of the total thickness variation of wafers sliced using previous systems and the exemplary systems described above in FIGS. 1-13. Each data series in the graph 900 is a box plot, the upper and lower bounds of each of the boxes represent the first and third quartiles of the data sets. The lines extending from opposite sides of the boxes terminate at the maximum and minimum values of the data sets. In the first data set of the graph 900, 4 meters of wire was used per wafer to cut the ingot into wafers, without the aid of the ultrasonic cleaning systems of FIGS. 1-13. In the second data set, 6 meters of wire was used per wafer and the ultrasonic cleaning systems of FIGS. 1-13 were utilized to clean the wire. Likewise, the ultrasonic cleaning systems were used to clean the wires in the third data set, although 4 meters of wire per wafer were used to slice the ingot into wafers. As shown in FIG. 17, the total thickness variation of wafers sliced in saws using the ultrasonic cleaning systems is significantly reduced compared to prior systems which did not use such cleaning systems.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description and shown in the accompanying drawing[s] shall be interpreted as illustrative and not in a limiting sense.

What is claimed is:

1. A system for ultrasonically cleaning one or more wires of a wire saw for slicing semiconductor or solar material into wafers, the system comprising:
an ultrasonic transducer connected to a sonotrode;
a sonotrode plate adjacent the one or more wires; and having a sonotrode opening exposing the sonotrode to the one or more wires;
a tank for delivering a flow of liquid for contacting the sonotrode and the one or more wires, the tank positioned on a same side of the wires as the sonotrode plate;
wherein the ultrasonic transducer is configured to vibrate and form cavitations in the liquid for removal of contaminants from a surface of the one or more wires.

2. A system as set forth in claim 1 wherein the one or more wires are diamond-coated.

3. A system as set forth in claim 1 wherein the one or more wires form a web of wires from a plurality of parallel wires.

4. A system as set forth in claim 3 wherein the sonotrode has a width that is substantially the same as the width of the web of wires.

5. A system as set forth in claim 1 comprising one or more manifolds for supplying liquid to the tank.

6. A method for ultrasonically cleaning one or more wires of a wire saw for slicing semiconductor or solar material into wafers, the method comprising:
ultrasonically agitating a liquid in contact with the one or more wires to cause cavitation in the liquid; and
cleaning the one or more wires by removal of contaminants deposited on the one or more wires using the cavitations in the liquid.

7. A method according to claim 6 wherein the liquid is ultrasonically agitated and the wire is cleaned while the one or more wires are disposed in the saw.

8. A method according to claim 6 wherein the liquid is ultrasonically agitated and the wire is cleaned while the one or more wires are not disposed in the saw.

9. A method according to claim 6 further comprising controlling the ultrasonic agitation of the liquid by controlling the amount of power output by the ultrasonic transducer, wherein the amount of power output by the ultrasonic transducer is controlled to be between about 50 W/m² and 200 W/m².

10. A method according to claim 6 wherein the cleaning of the one or more wires is performed for a time of about 4 hours to about 70 hours.

11. A system for ultrasonically cleaning one or more wires of a wire saw for slicing semiconductor or solar material into wafers, the system comprising:
an ultrasonic transducer connected to a sonotrode, the sonotrode positioned adjacent the one or more wires;
a tank for delivering a flow of liquid for contacting the sonotrode and the one or more wires, the tank positioned on an opposite side of the wires from the sonotrode;
wherein the ultrasonic transducer is configured to vibrate the sonotrode and form cavitations in the liquid for removal of contaminants from a surface of the one or more wires.

12. A system as set forth in claim 11 wherein the one or more wires are diamond-coated.

13. A system as set forth in claim 11 wherein the one or more wires form a web of a plurality of substantially parallel wires.

14. A system as set forth in claim 13 wherein the sonotrode has a substantially same width as a width of the web of wires.

15. A system as set forth in claim 11 comprising one or more manifolds for supplying liquid to the tank.
